(19) United States
(12) Patent Application Publication
(10) Pub. No.: US 2006/0269704 A1
(43) Pub. Date: Nov. 30, 2006

(54) Enclosure for portable electronic device and method for making the same

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/391,991

(22) Filed: Mar. 28, 2006

(30) Foreign Application Priority Data
May 28, 2005 (CN) 200510034959.8

(51) Int. Cl. B28B 11/00

(52) U.S. Cl. 428/34.4

(57) ABSTRACT

An enclosure (100) for a portable electronic device includes an aluminum base (10), an alumina film (20), and a diamond-like carbon film (30). The alumina film is formed on the aluminum base, and the diamond-like carbon film is formed on the alumina film A method for making the enclosure for a portable electronic device includes the steps of forming an aluminum base; anodizing an alumina film on a surface of the aluminum base, and then forming a diamond-like carbon film on the alumina film.

### BACKGROUND OF THE INVENTION

1. Field of the Invention

The present invention generally relates to portable electronic devices and, more particularly, to an enclosure for a portable electronic device and to a method for making the enclosure.

2. Discussion of the Related Art

With the development of information technology, portable electronic devices such as notebook computers, mobile phones, and personal digital assistants (PDAs) have become very popular. The appearance and feel of such electronic devices are sometimes decisive factors that influence a customer in purchasing them. Plastic material has many advantages such as its light weight, its low cost, its ease of manufacture, and its corrosion resistance. Therefore, enclosures of most portable electronic devices are made of plastic material. To enable plastic enclosures to have an attractive appearance, they are subjected to further processing such as electroplating and lacquering after initial injection molding. U.S. Pat. No. 4,350,739 discloses a process for producing a molded plastic part which may be used as an enclosure for a telephone. However, the plastic part has a hard and cold feel and is unremarkable in appearance. U.S. Pat. No. 5,123,988 discloses a process for producing a rubber extruded article having a cloth-like surface adhered to a rubber base via an adhesive layer. An enclosure formed to include the article can have a cloth-like surface. However, the process is complicated and costly. Moreover, after prolonged use, the adhesive layer can degenerate and allow the cloth-like surface to separate from the rubber.

Many different metallic materials such as steel and aluminum are widely used as enclosures for portable electronic apparatuses such as notebook computers, mobile phones, and personal digital assistants (PDAs). Enclosures made of such materials are usually treated by way of electroplating to provide better surface features. However, a conventional electroplated coating formed on the surface of an enclosure is frequently not durable.

U.S. Pat. No. 5,783,313 discloses a coated article. The coating includes a combination of nickel and palladium layers. The article can have improved brightness and resistance to abrasion. However, the coating is susceptible to fingerprint contamination. That is, fingerprints are easily formed and left on the coating. This adversely affects the aesthetic appearance of the article. Furthermore, the corrosion and wear resistance of the coating falls short of increasingly stringent requirements imposed by modern industrial standards.

Therefore, an enclosure for a portable electronic device which overcomes the above-mentioned problems is desired.

### SUMMARY OF THE INVENTION

In one aspect, an enclosure for a portable electronic device includes an aluminum base, an alumina film, and a diamond-like carbon film. The alumina film is formed on the aluminum base, and the diamond-like carbon film is formed on the alumina film.

In another aspect, a method for making an enclosure for a portable electronic device includes the steps of: forming an aluminum base; anodizing an alumina film on a surface of the aluminum base; and forming a diamond-like carbon film on the alumina film.

Other advantages and novel features will become more apparent from the following detailed description when taken in conjunction with the accompanying drawings.

### BRIEF DESCRIPTION OF THE DRAWINGS

Many aspects of the enclosure can be better understood with reference to the following drawings. The components in the drawings are not necessarily drawn to scale, the emphasis instead being placed upon clearly illustrating the principles of the present enclosure. Moreover, in the drawings, like reference numerals designate corresponding parts throughout the several views.

FIG. 1 is a schematic view of an enclosure in accordance with a preferred embodiment;.and

FIG. 2 is a cross-sectional view of the enclosure along line II-II in FIG. 1.

### DETAILED DESCRIPTION OF THE EMBODIMENT

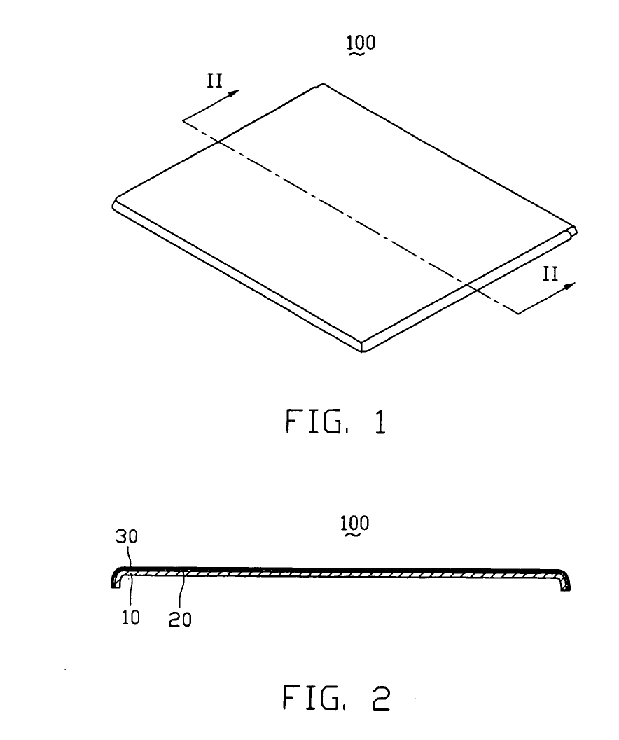

Referring to FIGS. 1 and 2, in a preferred embodiment, an enclosure 100 includes an aluminum base 10, an alumina film 20, and a diamond-like carbon film 30. The aluminum base 10 can be a front cover, back cover, slip cover, or slide cover of a portable electronic device, such as a notebook computer, a mobile phone, and a PDA. The base 10 is made of aluminum or aluminum alloy The alumina film 20 is an anodized film formed by anodizing a surface of the aluminum base 10, and the diamond-like carbon film 30 is deposited on a surface of the alumina film 20 so as to improve the wear resistance of the aluminum base 10 and the alumina film 20. The diamond-like carbon film 30 is made of a material selected from the group including amorphous C:H, amorphous C:N, and amorphous C:N:H (Where C is carbon, N is nitrogen and H is hydrogen). The alumina film 20 has an approximate thickness in the range of 10-200 nanometers, and the diamond-like carbon film 30 has an approximate thickness in the range of 10-100 nanometers.

The enclosure 100, with the alumina film 20 and the diamond-like carbon film 30, has good wear resistance and durability. The dual layers of the alumina film 20 and the diamond-like carbon film 30 also produce an attractive exterior with a smooth finish.

An exemplary method for making an enclosure 100 is provided. Firstly, an aluminum base 10 is formed by die or stamp molding. Secondly, an alumina film 20 is anodized on a surface of the aluminum base 10 in an anodizing solution. The anodizing solution can be a solution of alpha-hydro acid, or a combination solution including citric acid, tartaric acid, or malic acid. Thirdly, a diamond-like carbon film 30 is deposited on a surface of the alumina film 20 by either reactive sputtering or chemical vapor deposition. Types of reactive sputtering include DC (direct current) reactive sputtering, AC (alternating current) reactive sputtering, and RF (radio frequency) reactive sputtering. The diamond-like carbon film 30 is made of a material consisting of either amorphous C:H, amorphous C:N, or amorphous C:N:H. Thereby, an enclosure 100 is obtained.

When the diamond-like carbon film 30 is made of amorphous C:H by reactive sputtering, a gas mixture of argon and hydrogen, or a gas mixture of argon and methane/ethane, is used as sputtering gas. When the diamond-like carbon film 30 is made of amorphous C:N by reactive sputtering, a gas mixture of argon and nitrogen is used as sputtering gas. When depositing diamond-like film 30 by RF reactive sputtering, a RF power supply having a frequency of about 13.56 MHz should be provided.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. An enclosure for a portable electronic device, comprising:
an aluminum base;
an alumina film formed on the aluminum base; and
a diamond-like carbon film formed on the alumina film.

2. The enclosure as claimed in claim 1, wherein the alumina film is an anodized film formed by anodizing a surface of the aluminum base.

3. The enclosure as claimed in claim 1, wherein the diamond-like carbon film is made of a material selected from the group of amorphous C:H, amorphous C:N, and amorphous C:N:H, wherein C represents carbon, H represents hydrogen and N represents nitrogen.

4. The enclosure as claimed in claim 1, wherein the alumina film has an approximate thickness in the range of 10-200 nanometers.

5. The enclosure as claimed in claim 1, wherein the diamond-like carbon film has an approximate thickness in the range of 10-100 nanometers.

6. A method for making an enclosure for a portable electronic device, comprising the steps of:
forming an aluminum base;
anodizing an alumina film on a surface of the aluminum base; and
forming a diamond-like carbon film on the alumina film.

7. The method as claimed in claim 6, wherein the aluminum base is anodized in an anodizing solution comprising alpha-hydro acid.

8. The method as claimed in claim 6, wherein the aluminum base is anodized in an anodizing solution comprising citric acid, tartaric acid, and malic acid.

9. The method as claimed in claim 6, wherein the diamond-like carbon film is deposited by a method selected from reactive sputtering and chemical vapor deposition.

10. The method as claimed in claim 9, wherein the reactive sputtering is one of DC (direct current) reactive sputtering, AC (alternating current) reactive sputtering, and RF (radio frequency) reactive sputtering.
